(19) United States
(12) Patent Application Publication
(10) Pub. No.: US 2025/0121796 A1
(43) Pub. Date: Apr. 17, 2025

(54) Method and Apparatus for Checking a Digital Key for a Vehicle

(71) Applicant: Bayerische Motoren Werke Aktiengesellschaft, Muenchen (DE)

(72) Inventor: Matthias FINK, Muenchen (DE)

(21) Appl. No.: 18/884,627

(22) Filed: Sep. 13, 2024

(30) Foreign Application Priority Data
Oct. 13, 2023 (DE) 10 2023 128 010.4

(51) Int. Cl. B60R 25/24

(52) U.S. Cl. CPC B60R 25/241

(57) ABSTRACT

An apparatus for checking a digital target key of a device for a vehicle determines a sequence of key identifiers for a corresponding sequence of digital keys that have been used to derive the target key, and identifies the first key identifier in the sequence for a corresponding first key in the sequence of keys that has not yet been verified for the vehicle. The apparatus also obtains an attestation for the identified key from the device to verify the identified key on the basis of the obtained attestation, and to check the target key of the device on the basis of the verified identified key.

### CROSS REFERENCE TO RELATED APPLICATION

This application claims priority under 35 U.S.C. § 119 from German Patent Application No. DE 10 2023 128 010.4, filed Oct. 13, 2023, the entire disclosure of which is herein expressly incorporated by reference.

### BACKGROUND AND SUMMARY

The present disclosure relates to methods and corresponding apparatuses for checking a digital key for, and in particular on, a (motor) vehicle.

A vehicle can have one or more functions that can be controlled by a user of the vehicle by using an electronic device, e.g. a smartphone. The electronic device has a digital key that is examined by the vehicle in order to authenticate the electronic device and, following authentication of the electronic device, to permit control of one or more vehicle functions.

Illustrative vehicle functions are opening, or unlocking, and/or closing, or locking, a door or hatch of the vehicle, and/or starting the drive motor of the vehicle. Typically, the digital key is authenticated and/or the one or more vehicle functions are controlled by way of a wireless communication connection, in particular by way of a BLE (Bluetooth Low Energy) communication connection and/or by way of a near field communication (NFC) communication connection, between the vehicle and the electronic (key) device.

Authenticating the digital key of a key device for the first time can require transmission of a relatively large amount of data, which, in particular if an NFC communication connection is being used, can lead to the first-time authentication taking a relatively long time, which the user of the vehicle may find inconvenient.

The present document is concerned with a technical object of efficiently and reliably reducing the amount of data required for the first-time authentication of a key device for, in particular on, a vehicle, in particular in order to increase the convenience and/or energy efficiency of the control of one or more vehicle functions.

This object is achieved by the present disclosure. Advantageous embodiments are also described in the present disclosure. It is pointed out that additional features of a patent claim dependent on an independent patent claim without the features of the independent patent claim or only in combination with a subset of the features of the independent patent claim can form a dedicated invention that is independent of the combination of all features of the independent patent claim and that can be made the subject of an independent claim, a divisional application or a subsequent application. This applies in the same way to technical teachings which are described in the description and which can form an invention that is independent of the features of the independent patent claims.

According to one aspect, an apparatus for checking a digital target key of a (mobile and/or electronic) device for a (motor) vehicle is described. The device may be a smart device, in particular a smartphone. The target key may be stored in a secure memory area of the device. The apparatus may be part of the vehicle.

The apparatus is configured to determine a sequence of key identifiers for a corresponding sequence of digital keys that have been used to derive the target key. The sequence of key identifiers can be provided on the vehicle directly by the device (by way of a wireless (NFC and/or BLE) communication connection between the vehicle and the device). The sequence of key identifiers can be requested e.g. explicitly by the vehicle or can be provided by the device and/or read by the vehicle automatically (at the start of communication between the vehicle and the device). The sequence of digital keys is typically not (in particular not completely) available on the vehicle. The sequence of digital keys typically has a volume of data that is higher, in particular higher by a factor of 10 or more, or higher by a factor of 20 or more, or higher by a factor of 50 or more, or higher by a factor of 75 or more, than the volume of data in the corresponding sequence of key identifiers. In other words, the volume of data in the sequence of digital keys may be higher by a factor of 10 or more, or by a factor of 20 or more, or by a factor of 50 or more, or by a factor of 75 or more, than the volume of data in the corresponding sequence of key identifiers. The sequence of key identifiers can therefore be provided relatively efficiently (compared with the sequence of keys).

The sequence of key identifiers can have N key identifiers n=1, . . . , N, with N≥2. The N-th key identifier may be the key identifier for the target key of the device. Accordingly, the sequence of keys can have N keys, with the indices n=1, . . . , N. The individual keys may have been generated sequentially (starting with the key n=1 as far as the key n=N) by a central processing unit (e.g. by a backend server). The key n+1 may have been generated on the basis of the preceding key n. As such, the keys n=1 to n=N may gradually have been generated in order to form the sequence of keys, which leads to the target key that is intended to be checked, in particular verified, for the vehicle (e.g. for the purpose of controlling a vehicle function). The N keys may be associated with N different devices.

The sequence of keys may possibly have a key with the index n=0, and so the sequence of keys has a total of N+1 keys. The key with the index n=0 may be known in the vehicle in principle (e.g. right from when the vehicle is delivered). This key can be referred to as the base key. The base key can be used to sign the key with the index n=1.

Each of the individual keys of the sequence of keys may be designed according to the Car Connectivity Consortium, CCC, key standard, in particular according to CCC Release 3 or higher.

It can happen that the vehicle has no communication connection to the central processing unit (e.g. because the vehicle is parked in an underground garage). Consequently, at least some of the keys in the sequence of keys may be unknown to the vehicle. The vehicle can have a key memory, the key memory indicating the zero, one or more verified keys, and the key identifiers thereof, that have already been verified for (in particular by) the vehicle (e.g. in addition to the base key (with the index n=0), which is known in the vehicle in principle and is typically stored in the key memory in principle). It may thus be that a share of the keys in the sequence of keys and a corresponding share of the key identifiers in the sequence of key identifiers are not recorded in the key memory of the vehicle.

The apparatus is configured to identify the first key identifier in the sequence of key identifiers for the corresponding first key in the sequence of keys that has not yet been verified for (in particular by) the vehicle. The first key identifier in the sequence of key identifiers can be identified robustly and efficiently by using the key memory (of the vehicle).

The first key identifier may be the key identifier with the lowest index n, the corresponding key with the index n not yet having been verified, and the directly preceding key with the index n−1 having already been identified (and thus being held in the key memory). Furthermore, another condition for the first key identifier may be that all following keys with the indices n+1 to N have not yet been verified (and are thus not held in the key memory). The first key identifier can correspond to the n1-th key identifier in the sequence of key identifiers, e.g. where 1≤n1<N. In other words, the identified first key identifier can have the index n1.

It is thus possible to take the sequence of key identifiers as a basis (possibly even the sole basis) for identifying the first key in the sequence of keys that is to be verified next, in order to gradually verify the one or more as yet unverified keys in the sequence of keys, and finally the target key.

The apparatus is also configured to obtain an attestation for the identified key from the device. The attestation may be stored in a specific memory area of the device, and can be read (by the vehicle) from this memory area (by connecting the (NFC and/or BLE) communication connection). The sequence of key identifiers and/or the attestation may thus be stored on the device and can be obtained by the vehicle by way of a wireless (BLE and/or NFC) communication connection.

The attestation for the identified key (with the index n1) may have been signed using a central key of the central processing unit. As already explained, the sequence of keys may have been generated (gradually) by the central processing unit. Furthermore, the attestation for the identified key (with the index n1) may have been signed using the preceding key (with the index n1 −1) that has the preceding key identifier (with the index n1−1) in the sequence of key identifiers that is disposed directly in front of the identified key identifier (with the index n1) in the sequence of key identifiers. Furthermore, the attestation for the identified key (with the index n1) can comprise the identified key itself.

The apparatus is also configured to verify the identified key (with the index n1) on the basis of the obtained attestation. The apparatus may in particular be configured to verify the identified key (with the index n1) on the basis of the obtained attestation and on the basis of the preceding key (with the index n1−1) in the sequence of keys, the preceding key (with the index n1−1) having the preceding key identifier (with the index n1−1) in the sequence of key identifiers that is disposed directly in front of the identified key identifier (with the index n1) in the sequence of key identifiers.

The apparatus may also be configured to include the respective verified identified key (with the index n1) with the identified key identifier (with the index n1) in the key memory.

Furthermore, the apparatus may be configured to verify the key with the subsequent (n1+1)-th key identifier in the sequence of key identifiers by using the attestation for the key with the subsequent (n1+1)-th key identifier and by using the previously verified key with the n1-th key identifier.

In addition, the apparatus is configured to check the target key of the device on the basis of the verified identified key. For this purpose, the apparatus may be configured, iteratively for n=n1+1 to N, to obtain the attestation for the key with the n-th key identifier and to verify the key with the n-th key identifier on the basis of the respective obtained attestation and by using the key with the (n−1)-th key identifier, in order to finally (for n=N) verify the target key of the device as the key with the N-th key identifier.

An apparatus (for a vehicle) is thus described that permits the first as yet unverified key to be identified efficiently and reliably (on the basis of the sequence of key identifiers), so that it is typically not necessary to obtain (by way of the communication connection) the attestations for all keys in the sequence of keys. This permits an efficient, secure and reliable check on the target key for a device.

The sequence of key identifiers can indicate the version of each of the individual keys used in the corresponding sequence of keys. One or more keys in the sequence of keys may possibly have multiple possible different versions.

The apparatus may be configured to identify the first key identifier (with the index n1) in the sequence of key identifiers for the corresponding first key (with the index n1) in the sequence of keys that has not yet been verified for, in particular by, the vehicle with the respective indicated version. A condition predefined for identifying the first key identifier may thus be that
the key with the index n1 has not yet been verified in the version indicated in the sequence of key identifiers;
the key with the index n1−1 has already been verified in the version indicated in the sequence of key identifiers; and
the one or more keys with the indices n1+1 to N have possibly not yet been verified in the respective version indicated in the sequence of key identifiers.

Taking account of the version of the individual keys allows the flexibility for allocating keys and the associated rights for controlling one or more vehicle functions to be efficiently, securely and reliably increased.

The apparatus may be configured to use the identified key identifier (with the index n1) to determine a subarea of the memory area of the device, in particular a pointer to the subarea of the memory area of the device, in which the attestation for the identified key (with the index n1) is stored. The attestation for the identified key (with the index n1) can then be read (by way of the (NFC and/or BLE) communication connection) from the determined subarea particularly efficiently and robustly.

Each of the individual digital keys of the sequence of keys may be designed according to a specific (in particular asymmetric) cryptosystem, or cryptographic method, in particular elliptic curve cryptography (ECC). The apparatus may be designed to use the public portion of each of the individual digital keys in order to manipulate an attestation and/or in order to verify a digital key. In particular, the attestation for the digital key with the index n may
comprise the public portion of the digital key with the index n;
have been signed using the private portion of the digital key with the index n−1; and/or
have been signed using the private portion of the central key of the central processing unit.

The apparatus may be configured to verify the attestation for the digital key with the index n
by using the public portion of the digital key with the index n−1; and/or
by using the public portion of the central key of the central processing unit.

Each of the public portions of the individual digital keys may be stored in the key memory (of the vehicle).

According to another aspect, a (road) motor vehicle (in particular a passenger vehicle or truck or bus or motorcycle) is described that comprises one or more of the apparatuses described in this document.

According to another aspect, another apparatus for checking a digital target key of a device for a vehicle is described. The apparatus may be part of the device. The features described in this document can also be applied individually or in combination to this apparatus (in particular analogously or appropriately to the features embodied by the corresponding apparatus of the vehicle).

The apparatus is configured to provide (the vehicle with) a sequence of key identifiers for a corresponding sequence of keys that have been used to derive the target key. The apparatus is also configured to receive (from the vehicle) a request to provide the attestation for a key in the sequence of keys that has been identified by a key identifier in the sequence of key identifiers. In addition, the apparatus is configured to provide (the vehicle with) the requested attestation, in particular by way of a wireless communication connection.

According to another aspect, a (mobile and/or portable) user device (e.g. a smart device and/or a smartphone) is described that comprises one or more of the apparatuses described in this document.

According to one aspect, a method for checking a digital target key of a device for a (motor) vehicle is described. The method comprises determining a sequence of key identifiers for a corresponding sequence of digital keys that have been used to derive the target key. The method also comprises identifying the first key identifier in the sequence of key identifiers for a corresponding first key in the sequence of keys that has not yet been verified for the vehicle. In addition, the method comprises obtaining an attestation for the identified key from the device, verifying the identified key on the basis of the obtained attestation and checking the target key of the device on the basis of the verified identified key.

According to one aspect, a method for checking a digital target key of a device for a (motor) vehicle is described. The method comprises providing a sequence of key identifiers for a corresponding sequence of keys that have been used to derive the target key. In addition, the method comprises receiving a request to provide an attestation for a key in the sequence of keys that has been identified by a key identifier in the sequence of key identifiers, and providing the requested attestation, in particular by way of a wireless communication connection.

According to another aspect, a software (SW) program is described. The SW program may be configured to be executed on a processor and to thereby carry out one or more of the methods described in this document.

According to another aspect, a storage medium is described. The storage medium can comprise an SW program that is configured to be executed on a processor and to thereby carry out one or more of the methods described in this document.

It should be noted that the methods, apparatuses and systems described in this document can be used either alone or in combination with other methods, apparatuses and systems described in this document. In addition, any aspects of the methods, apparatuses and systems described in this document can be combined with one another in a wide variety of ways. In particular, the features of the claims can be combined with one another in a wide variety of ways. Furthermore, features between parentheses should be understood to be optional features.

The text below describes the present disclosure in more detail on the basis of exemplary embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1a shows an illustrative digital entry system of a vehicle;

FIG. 1b shows an illustrative key device;

FIG. 1c shows an illustrative sequential transfer of digital keys;

FIG. 1d shows an illustrative sequence of digital keys and corresponding attestations;

FIG. 2a shows an illustrative first-time authentication of a key device on a vehicle;

FIG. 2b shows an illustrative key memory;

FIG. 3a shows an illustrative key memory containing key identifiers and version details;

FIG. 3b shows an illustrative sequence of key identifiers;

FIG. 3c shows an illustrative memory area of a key device;

FIG. 4a shows a flowchart for an illustrative method for checking an unknown digital key; and

FIG. 4b shows a flowchart for another illustrative method for checking an unknown digital key.

### DETAILED DESCRIPTION OF THE DRAWINGS

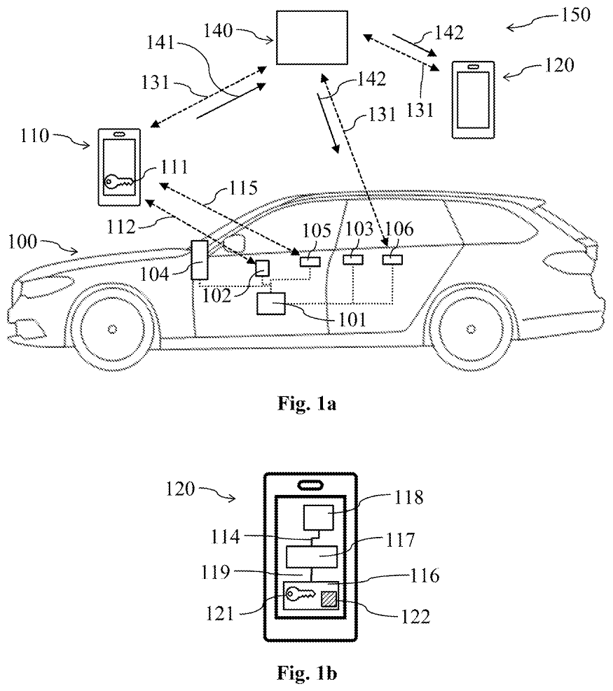

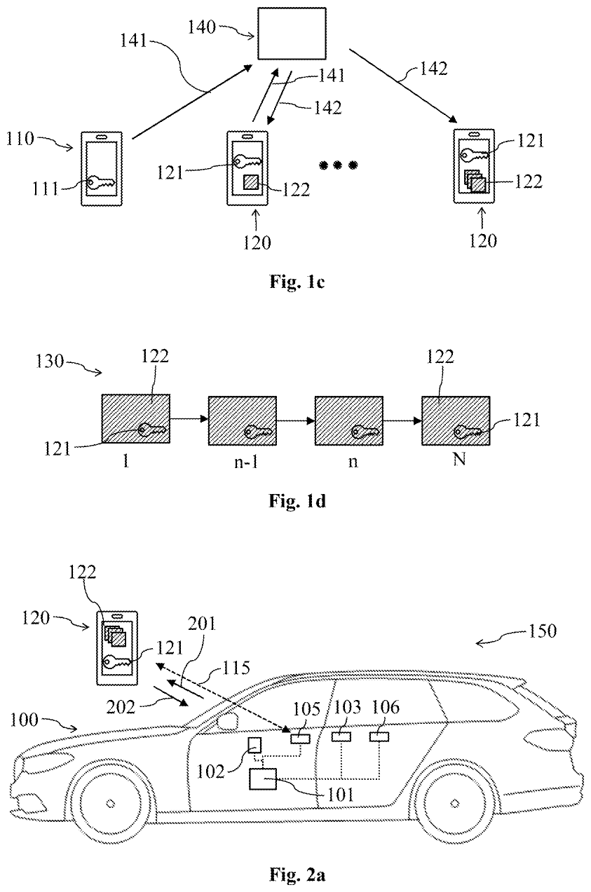

As explained at the outset, the present document is concerned with increasing the convenience and/or energy efficiency of the first-time check on, in particular authentication of, the digital key of a digital key device. In this context, FIG. 1a shows an illustrative (entry) system 150 that comprises at least one vehicle 100 and a digital key device 110. The digital key device 110 is typically a portable electronic device, e.g. a smartphone or a tablet PC, a digital key 111 being stored in the portable electronic device. The digital key 111 may be stored in a protected memory area, in particular in a so-called “secure element”, of the portable electronic device (for instance the user device).

The digital key device 110 is designed to use one or more different wireless communication connections 112, 115 to communicate with a communication unit 102, 105 of the vehicle 102. Illustrative communication connections 112, 115 are a Bluetooth Low Energy (BLE) communication connection 112 and/or a near field communication (NFC) communication connection 115.

The system 150 also comprises a central processing unit 140, e.g. a backend unit, or a backend server, that is configured to use a respective wireless communication connection 131 (e.g. to use a 3G, 4G or 5G communication connection) to communicate with the digital key device 110 and/or with the vehicle 100 (in particular with a communication unit 106 of the vehicle 100).

A (control) apparatus 101 of the vehicle 100 may be designed to control at least one vehicle function 103 of the vehicle 100 according to the communication between the device 110 and the vehicle 100. In this context, the digital key 111 of the device 110 can be verified, in particular authenticated. Furthermore, following successful authentication, one or more vehicle functions 103 can be controlled, in particular according to.
the distance between the device 110 and the vehicle 100;
the position of the device 110 relative to the vehicle 100; and/or
a control command sent from the device 110 to the vehicle 100 by way of a communication connection 112, 115.

The scope of the one or more vehicle functions 103 that can be controlled by the key device 110 may be dependent on one or more properties of the digital key 111. In particular, there may be the option of using the digital key 111 to enable one or more vehicle functions 103 and/or to disable one or more vehicle functions 103.

The user of the key device 111 can be permitted to authorize another user and/or another electronic device 120 to control one or more vehicle functions 103. For this purpose, the key device 111 can cause the other electronic device 120 to be provided with a digital key that possibly defines the scope of the one or more vehicle functions 103 that can be controlled by the other electronic device 120.

The key device 110 can use the communication connection 131 to send a transfer prompt 141 to the central processing unit 140, which is aimed at causing the central processing unit 140 to transfer a digital key to another device 120. The transfer prompt 141 may be signed using the digital key 111 of the key device 110. Furthermore, the transfer prompt 141 may possibly define the scope of functions of the key to be transferred.

The central processing unit 140 can then generate a digital key for the other electronic device 120. This digital key can be transferred (in appropriate messages 142) to the vehicle 100 and to the other electronic device 120 together with an attestation for this digital key. The attestation can be used by the vehicle 100 to check the authenticity of the digital key for the other electronic device 120. For this purpose, the vehicle 100 requires the digital key 111 of the key device 110 that has initiated the transfer of a digital key. Furthermore, the central key of the central processing unit 140, which has been used to sign the attestation for the digital key for the other electronic device 120, is typically required.

It is possible to use e.g. an asymmetric method for encryption (e.g. elliptic curve cryptography (ECC)). A digital key can be verified on the vehicle 100 by using the respective public portion of a key (e.g. the public portion of the central key and/or the public portion of the respective digital key).

FIG. 1b shows details of the other electronic device 120. In particular, FIG. 1b shows the secure memory area 116, in particular the so-called “secure element” that is used to store the digital key 121 provided for the electronic device 120 and possibly the attestation 122 of this digital key 121. The attestation 122 may alternatively be stored in another (insecure) memory area, since the attestation 122 is already protected (by the signature with the preceding key 111, 121 and by the signature with the central key of the central processing unit 140).

The memory area 116 can be read by the operating system and/or by a control apparatus 117 of the device 120 by way of a (secure) data interface 119. Furthermore, the operating system and/or the control apparatus 117 can transfer data from the memory area 116, e.g. the digital key 121 and/or the attestation 122, to a software application 118 of the device 120 by way of another data interface 114.

It can happen that there is no communication connection 131 between the central processing unit 140 and the vehicle 100 when the key 121 is being transferred to the electronic device 120, and so the digital key 121 and the attestation 122 cannot be sent to the vehicle 100 (within a message 142), but rather can only be sent to the electronic device 120.

The digital key 121 (together with other meta data) is typically held in the attestation 122, and so the vehicle 100 and/or the electronic device 120 are provided only with the attestation 122 (within the message 142). The digital key 121 can be extracted from this attestation 122 (using the (public portion of the) central key of the central processing unit 140 and/or the (public portion of the) key 111, 121 that has been used to deduce the digital key 121).

If, in a case in which the attestation 122 has not been able to be sent to the vehicle 100, the electronic device 120 approaches the vehicle 110 for the first time, the apparatus 101 of the vehicle 100 examines whether the device 120 and the digital key 121 are already known on the vehicle 100. If this is not the case, the device 120 can use the communication connection 112, 115 to provide the vehicle 100 with the attestation 122. The vehicle 100 can then use the provided attestation 122 to check the authenticity of the digital key 121.

The user of the device 120 can be permitted to cause a digital key to be transferred to another device 120, as depicted by way of illustration in FIG. 1c. The other device 120 can then be provided with a digital key 121 and an associated attestation 122 (in a message 142 in each case). It is thus sequentially possible to set up a sequence, in particular a chain, 130 of digital keys 121, each of the individual keys 121 being associated with an attestation 122 (as depicted by way of illustration in FIG. 1d). The sequence 130 of digital keys 121 that is shown in FIG. 1d comprises a total of N keys 121, which follow one another sequentially from n=1 to n=N. The N-th key 121 in the sequence 130 of keys 121 can be referred to as the target key of the last device 120 in the succession of devices 120.

If there is no communication connection 131 between the central processing unit 140 and the vehicle 100 when the digital key 121 is being transferred to a device 120, the receiving device 120 can be provided with the attestations 122 for multiple, in particular for all, digital keys 121 from the sequence of keys 121, and so a sequence of attestations 122 (for the corresponding sequence 130 of keys 121) is stored in the memory area 116 of the receiving device 120. At least part of this sequence of attestations 122 can be delivered to the vehicle 100 for a first-time check on the digital key (in particular the target key) 121 of the receiving device 120 in order to permit a reliable authentication of the digital key 121.

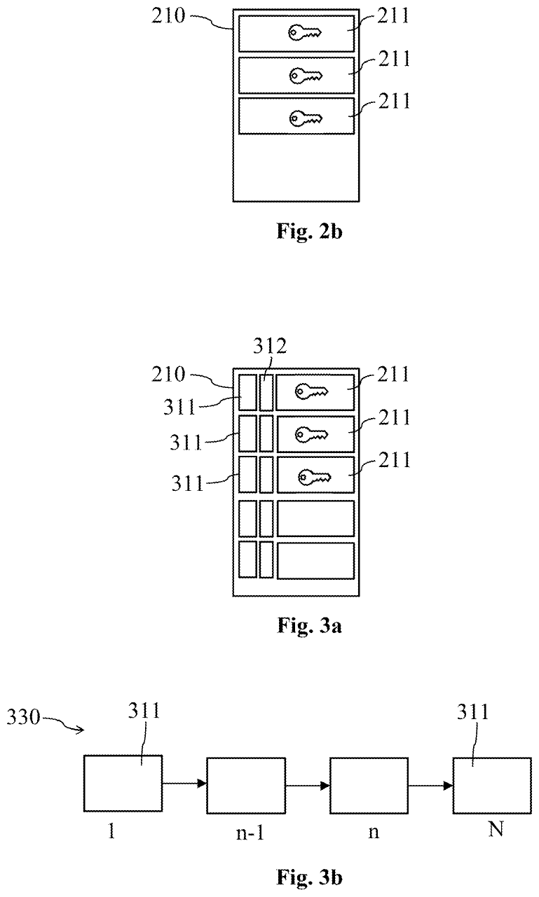

FIG. 2a shows an illustrative situation in which an electronic device 120 uses a digital key (in particular uses a target key) 121, which has been deduced from a sequence 130 of digital keys 121, to register on a vehicle 100 for the first time. The attestations 122 for the sequence 130 of digital keys 121 are stored on the electronic device 120. If one or more of the keys 121 from the sequence 130 of digital keys 121 are unknown on the vehicle 100, the attestations 122 for these keys 121 can be transmitted between the vehicle 100 and the device 120 sequentially by way of the communication connection 115.

FIG. 2b shows an illustrative key memory 210 of the vehicle 100, in which the known, i.e. already verified, keys 121 are stored. The key memory 210 may possibly comprise one or more keys 121 from the key sequence 130.

To perform the check on the digital key, i.e. the target key, 121 of the device 120 disposed at the vehicle 100, transmission of the attestation 122 for the last key N (i.e. for the target key) 121 from the key sequence 130 can be started, and attestations 122 as far as the first key n1 121 in the sequence 130 of keys 121, which is not yet known on the vehicle 100, can then be requested and transmitted. The obtained attestations 122 (at least some of them, in particular the share of the attestations 122 that is relevant to the respective key 121) must then be stored in a memory area of the vehicle 100 so as to gradually verify, starting from the known key n1−1 121, the attestations 122 as far as the last key N 121. This “leaf-to-root” method entails a relatively high memory requirement in the vehicle 100.

On the other hand, all attestations 122 from the first key n=1 121 to the last key N 121 can be sequentially transmitted to the vehicle 100 and sequentially verified. This “root-to-leaf” method constantly requires the transmission of all attestations 122 for the key sequence 130, which can lead to a relatively large amount of data and thus to a relatively long period for checking the target key 121 of the device 120 disposed at the vehicle 100.

The relatively long period for checking the target key 121 of the device 120 disposed at the vehicle 100 can be caused in particular by the data bus (e.g. a LIN bus) between the communication unit 102, 105 of the vehicle 100 and the control apparatus 101, which bus possibly has a relatively low data transmission rate. It may possibly be necessary for the user to keep the device 120 at the communication unit 102, 105 (in particular at the NFC reader) until all required attestations 122 have been read and processed.

The “root-to-leaf” method, on the other hand, has the advantage that keys 121 are verified and stored in the vehicle 100 gradually, and so after the transmission process has been terminated (e.g. when the user takes the device 120 away from the communication unit 102, 105), the attestation 122 can be restarted directly at the keys 121 at which the transmission process was terminated.

Each of the individual keys 121 of the key sequence 130 can be identified by a key identifier, the key identifier of a key 121 being much smaller, in terms of the amount of data, than the key 121 itself. The amount of data in the key 121 may be greater than the amount of data in the corresponding key identifier e.g. by a factor of 10 or more.

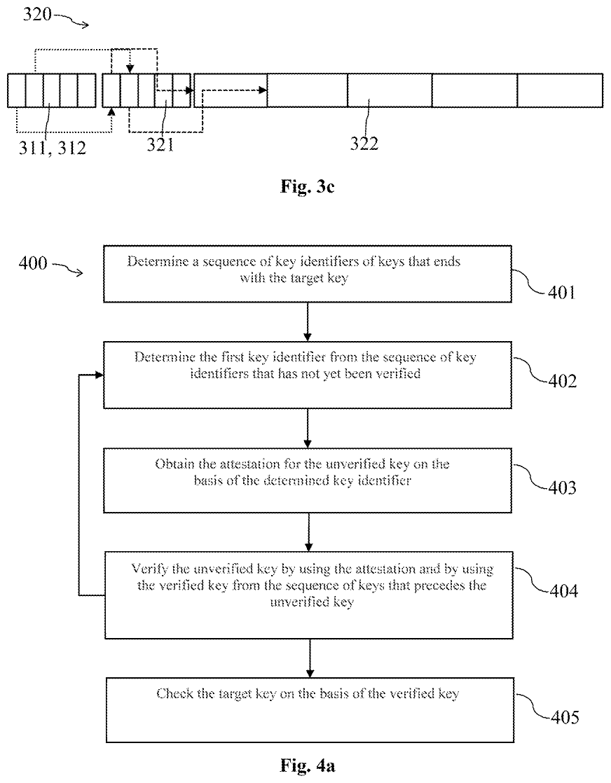

The sequence 130 of keys 121 can be represented by a corresponding sequence 330 of key identifiers 311, as depicted by way of illustration in FIG. 3b. The device 120 disposed at the vehicle 100 may be designed to provide the vehicle 100 with the sequence 330 of key identifiers 311 by way of the communication connection 115 (e.g. automatically or in response to a request from the vehicle 100).

FIG. 3a shows an illustrative key memory 210 of the vehicle 100, which, for each of the keys 121 known (and already verified) on the vehicle 100, indicates the key identifier 311 of the respective key 121. In addition, the version 312 of the key 121 that has been verified by the vehicle 100 may be indicated for each of the individual keys 121. Taking account of the version 312 of a key 121 permits the scope of functions of the one or more vehicle functions 103 that can be controlled using the key 121 to be subsequently changed.

FIG. 3c shows an illustrative memory area 320 of the device 120 for storing the attestations 122 of the sequence 130 of keys 121 that leads to the digital key 121 of the device 120. The memory area 320 can be referred to as a “mailbox” in which the attestations 122 received from the central processing unit 140 can be stored.

The memory area 320 has a first subarea in which the key identifiers 311 and possibly the respective versions 312 of the individual keys 121 of the key sequence 130 may be sequentially stored. In addition, the memory area 320 can have a second subarea in which, for each of the individual key identifiers 311, a pointer 321 that refers to the start of the subarea 322 for the attestation 122 of the key 121 associated with the key identifier 311 may be stored. As such, the attestations 122 for the keys 121 of the key sequence 130 can be stored efficiently.

A first-time check on the digital key (i.e. the target key) 121 of the device 120 disposed at the vehicle 100 can result in the vehicle 100 taking the sequence 330 of key identifiers 311 and the key memory 210 of the vehicle 100 as a basis for identifying the first key identifier 311 from the sequence 330 of key identifiers 311, which is associated with a key n1 121 that has not been verified (in the required version 312) to date (and is thus not recorded in the key memory 211, at least not in the required version 312). The identified key with the index n1 can fulfil the following conditions:
the identified key with the index n1 is not held in the key memory 210 (at least not in the required version 312);
the directly preceding key with the index n1−1 is held (in the required version 312) in the key memory 210; and/or
the one or more subsequent keys with the indices n1+1 to N are not held in the key memory 210 (at least not in the respective required version 312).

A message 201 that is sent from the vehicle 100 to the device 120 by way of the communication connection 115 can then be used to request the attestation 122 for the identified key n1 121. The memory location 322 (i.e. the subarea of the memory area 320) of this attestation 122 can be determined efficiently on the basis of the pointer 321 indicated for the key identifier 311 of the identified key n1 121.

The attestation 122 for the identified key n1 121 can then be sent from the device 120 to the vehicle 100 in at least one message 202. The message 202 can consist of a sequence of messages (containing messages in both transmission directions). Alternatively or additionally, the memory location 322 of the attestation 122 can be read directly. Furthermore, the identified key n1 121 can be verified on the basis of the provided attestation 122. For this purpose, the vehicle 100 uses the already verified key n1−1 121 (which is stored in the key memory 210, and which is disposed directly in front of the key n1 121 in the key sequence 130). After the key n1 121 has been verified, it can be included in the key memory 210.

The vehicle 100 can then (use the sequence 330 of key identifiers 311 to) identify the (directly) subsequent unverified key n1+1 121 from the key sequence 130, and the attestation 122 for this key n1+1 121 can be obtained from the device 120. Furthermore, the key n1+1 121 can be verified on the basis of the obtained attestation 122 (using the previously verified key n1 121). Furthermore, the verified key n1+1 121 can be stored in the key memory 210.

Accordingly, the as yet unverified keys 121 from the key sequence 130 can be sequentially verified until finally the unknown key 121 of the device 120 (as the N-th key 121) can be verified.

Provision of the sequence 330 of key identifiers 311 for the corresponding sequence 130 of keys 121 that has been used to derive the key 121 to be checked of an electronic device 120 permits an efficient check on the key 121 that is to be checked, requiring only the attestations 122 of the one or more keys 121 that have not yet been verified by the vehicle 100 to be transmitted from the device 120 to the vehicle 100. The transmission can take place in sequentially ascending order, and so only one attestation 122 need be stored on the vehicle 100 in each case. As such, the amount of data to be transmitted and/or the memory requirement can be reduced and, as a result, convenience and/or energy efficiency can be increased.

The electronic device 120, which would like to register on the vehicle 100 using a specific target key 121 (i.e. the key 121 to be checked), thus has a list of attestations 122 (the attestations also possibly also being able to be referred to as certificates). Furthermore, the device 120 has a list 330 of identifiers 311 of the keys 121 to which the individual attestations 122 relate. The list 330 of identifiers 311 can be provided to the vehicle 100, and so the vehicle 100 can check in advance which attestations 122 can be skipped and/or ignored (so that the efficiency of the check is increased). The vehicle 100 can request the attestation 122 of the next unknown key 121. Furthermore, the unknown key 121 can be checked on the basis of the attestation 122 for this key 121. In addition, the checked key 121 can be included in the key memory 210 (in particular in the key table). Moreover, the attestation 122 of the checked key 121 can be discarded (in order to reduce the memory requirement), and in a subsequent iteration the procedure can continue with the subsequent unknown key 121.

Thus, only the attestations 122 that are actually needed in each case are transmitted, which can reduce the memory requirement on the vehicle 100, and/or which can reduce the transmission time for transmission of the attestations 122, and which can speed up the check.

The list 330 containing the key identifiers 311 can be stored in the secure memory area 116, 320 of the device 120. If necessary, appropriate configuration can cause the list 330 containing the key identifiers 311 to be automatically transmitted to the vehicle 100 (without this being explicitly requested by the vehicle 100) for every authentication. This allows the authentication process to be sped up further. Alternatively, the list 330 containing the key identifiers 311 can be stored in a dedicated subarea of the memory area 320 (e.g. before the subarea 322 for the attestations 122). The list 330 can then be retrieved by way of a dedicated request from the vehicle 100.

As already explained, the version 312 of the respective key 121 can be indicated together with the individual keys 121 and/or key identifiers 311 in order to further increase flexibility when transferring keys 121.

The individual attestations 122 may be disposed in dedicated subareas 322 of the memory area 320 of the device 120. Alternatively, the individual attestations 122, as explained in connection with FIG. 3c, may be stored in subareas 322 that are indicated by an offset value or pointer 321. The latter measure can typically reduce the memory requirement.

In one example, the user approaches the vehicle 100 with their device 120, which has an unknown key 121. The unknown key 121 has e.g. the identifier 1003. The unknown key 121 has been generated from the sequence 130 of keys 121 with the identifiers 1000, 1001, 1002. The vehicle 100 knows e.g. the keys 1000 and 1001 (which are recorded in the key memory 210). The mailbox, or memory area, 320 of the device 120 contains the attestations 122 for the keys 1000 to 1003.

The vehicle 100 receives (from the device 120) the list, or the sequence, 330 of identifications (i.e. 1000, 1001, 1002, 1003). This can be done implicitly, or automatically, or by way of explicit request.

The vehicle 100 checks the identifiers from left (i.e. from the root) to right (i.e. as far as the leaf). On the basis of the key memory 210, it is recognized that the keys with the identifiers 1000 and 1001 are already known to the vehicle 100 (and so no attestations 122 need to be obtained for these keys). Furthermore, it is recognized that the key with the identifier 1002 is not known. The attestation 122 for this key is then retrieved. In addition, the attestation 122 is analyzed and verified. This is done using the key with the identifier 1001 (i.e. using the preceding key), in particular by checking the signature.

If the result is positive, the key with the identifier 1002 is included in the key memory 210 as verified and/or known. The procedure then continues with the key with the identifier 1003. The corresponding attestation 122 is again retrieved, analyzed and verified (using the key with the identifier 1002). If the result is positive, the key with the identifier 1003 is included in the key memory 210 as verified and/or known, and so the target key is now known to the vehicle 100.

If necessary, the version 312 of the individual keys 121 can additionally be considered in order to check whether or not the known keys on the vehicle 100 are out of date. Alternatively or additionally, the pointers 321 to the individual attestations 122 can be used in order to be able to access the individual attestations 122 in the memory area 320 of the device 120 particularly efficiently.

It is then possible to check, for the individual keys 121 in the key memory 210 of the vehicle 100, whether the respective key 121 is known with the correct data version 312 (or whether only a corresponding key 121 with a different, in particular earlier, data version 312 is possibly known). If it is recognized that a verified key from the key memory 210 (e.g. the key with the identifier 1001) has a different (in particular earlier) data version 312, this key can be dealt with as though the key were unknown. The attestation 122 for this key can then be obtained in order to verify the key.

By way of example, the rights for a preceding key 121 in a current version 312 may have been extended. At least some of the extended rights can be transferred to a subsequent key 121, the preceding key 121 in its current version 312 being stored in the key sequence 130 for the subsequent key 121. As a result of this measure, the subsequent key 121 can be verified with the extended rights only if the preceding key 121 in its current version 312 has previously been verified.

The transfer of rights for controlling one or more vehicle functions 103 is typically limited to the set of rights that apply to the key 121 which is being transferred. Assuming a specific digital key 121, it is thus typically possible for only at most the set of rights that is connected to, or associated with, the specific digital key 121 to be transferred.

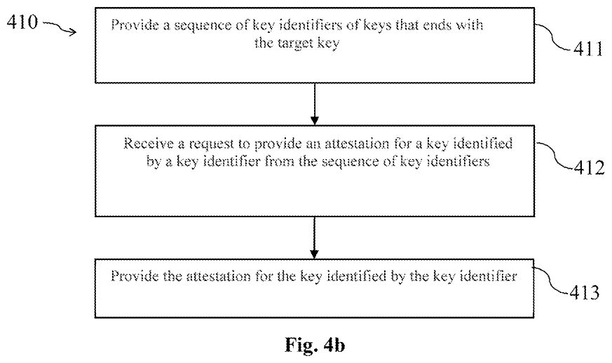

FIG. 4a shows a flowchart for an illustrative (possibly computer-implemented) method 400 for checking a digital target key 121 of a device 120 for a vehicle 100. The method 400 can be carried out on and/or by the vehicle 100 (in particular by a control apparatus 101 of the vehicle 100). The device 120 may be an electronic device, for instance a smart device. The device 120 may in particular be in the form of a key device described in this document.

The method 400 comprises determining 401 a sequence 330 of key identifiers 311 for a corresponding sequence 130 of digital keys 121 that have been used to derive the target key 121. The sequence 330 of key identifiers 311 can be provided by the device 120. In particular, the sequence 330 of key identifiers 311 can be read from a memory area 320 of the device 120 (by way of a wireless (NFC or BLE) communication connection 112, 115).

The individual keys 121 and/or the individual key identifiers 311 can each be identified by an index n, where n=1, . . . , N. The N-th key 121 can correspond to the target key 121. The keys 121 and/or the key identifiers 311 may be disposed within the respective sequence 130, 330 with a rising index n (i.e. starting with n=1 and ending with n=N). The key n+1 may have been generated on the basis of the preceding key n (for n=1 to N−1). The individual keys 121 may have been generated by a central processing unit 140, e.g. by a backend server.

The method 400 also comprises identifying 402 the first key identifier 311 in the sequence 330 of key identifiers 311 for the corresponding first key 121 in the sequence 130 of keys 121 that has not yet been verified for the vehicle 100. For this purpose, a key memory 210 (of the vehicle 100) can be accessed that indicates the zero, one or more keys 121 that have already been verified for (in particular by) the vehicle 100. The first key identifier 311, i.e. the key identifier 311 with the lowest index n, that has not yet been verified can then be identified.

The first key identifier 311 and the first key 121 can be identified in such a way that all subsequent keys 121 in the sequence 130 of keys 121 have not yet been verified for (in particular by) the vehicle 100 either. Furthermore, the first key identifier 311 and the first key 121 can be identified in such a way that the preceding key 121 disposed directly in front of the first key 121 (in the sequence 130 of keys 121) has already been verified for (in particular by) the vehicle 100 (and is therefore indicated in the key memory 210).

The method 400 also comprises obtaining 403 an attestation 122 for the identified key 121 from the device 120. The attestation 122 can be read (by way of a wireless (NFC or BLE) communication connection 112, 115) from a specific subarea 322 of the memory area 320 of the device 120. The attestation 122 can indicate the authenticity of the identified key 121. For this purpose, the attestation 122 may have been signed by the central processing unit 140 and/or by using the preceding key 121.

In addition, the method 400 comprises verifying 404 the identified key 121 on the basis of the obtained attestation 122. For this purpose, the attestation 122 can be checked, or verified, by using the preceding key 121 and/or by using a central key of the central processing unit 140. Individual, encrypted, fields of the attestation 122 can be decoded using a key that is known to the vehicle 100. Following successful verification, the identified key 121 can be included in the key memory 210 as a verified key 121.

The method 400 can also comprise checking 405 the target key 121 of the device 120 on the basis of the verified identified key 121. For this purpose, the as yet unverified keys 121 in the sequence 130 of keys 121 can be sequentially verified (by using method steps 402, 403, 404), until finally the N-th key in the key sequence 130, and thus the target key 121, is verified and therefore checked. This is represented in FIG. 4a by the arrow that runs from step 404 to step 402.

The actual checking, in particular the verification, of the target key 121 of the device 120, i.e. the N-th key 121 of the sequence 130 of keys 121, is performed in the same way as the checking, in particular verification, of the N−1-th key 121, and the N−2-th key 121, etc. Starting from the identified key 121 (with n=n1), the keys 121 are thus iteratively verified as far as the target key 121 (with n=N) in the same way.

When the target key 121 of the device 120 has been verified on the vehicle 100, the target key 121 can be used for controlling one or more vehicle functions 103. In particular, the apparatus 101 of the vehicle 100 can cause a vehicle function 103 associated with the target key 121 to be performed. By way of example, the door of the vehicle 100 can be automatically opened following a successful check on the target key 121. Other illustrative vehicle functions 103 are starting the engine, controlling the window lifter, etc. Control of the one or more vehicle functions 103 then requires no fresh processing of the attestation 122 of the target key 121.

FIG. 4b shows a flowchart for an illustrative (possibly computer-implemented) method 410 for checking a digital target key 121 of a device 120 for a vehicle 100. The method 410 can be carried out on the device 120, in particular on a control apparatus 117 of the device 120. The features described in this document can also be applied, individually or in combination, to this method 410 (in particular in complementary fashion to the method steps that are carried out for, in particular by, the vehicle 100).

The method 410 comprises providing 411 a sequence 330 of key identifiers 311 for a corresponding sequence 130 of keys 121 that have been used to derive the target key 121. The sequence 330 of key identifiers 311 may be stored in a memory area 320 of the device 120. The vehicle 100, in particular a control apparatus 101 of the vehicle 100, can be permitted to read the sequence 330 of key identifiers 311 from this memory area 320 (by way of a wireless (NFC or BLE) communication connection 112, 115).

In addition, the method 410 comprises receiving 412 a request 201 to provide an attestation 122 for a key 121 in the sequence 130 of keys 121 that has been identified by a key identifier 311 in the sequence 330 of key identifiers 311. In particular, it is possible (for the vehicle 100) to request the authorization to read a specific subarea 322 of the memory area 320 of the device 120 (by way of a wireless (NFC or BLE) communication connection 112, 115).

The method 410 also comprises providing 413 the requested attestation 122, in particular by way of the wireless communication connection 112, 115.

The measures described in this document can be used to verify the target key 121 of a device 120 efficiently and reliably for a vehicle 100. This permits particularly convenient, flexible and secure control of one or more vehicle functions 103 by different electronic devices 110, 120.

The present invention is not restricted to the exemplary embodiments shown. In particular, it should be noted that the description and the figures are intended to illustrate the principle of the proposed methods, apparatuses and systems only by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for checking a digital target key of a device for a vehicle, wherein the apparatus is configured to:
determine a sequence of key identifiers for a corresponding sequence of digital keys that have been used to derive the target key;
identify a first key identifier in the sequence of key identifiers for a corresponding first key in the sequence of keys that has not yet been verified for the vehicle;
obtain an attestation for the identified key from the device;
verify the identified key on a basis of the obtained attestation; and
check the target key of the device on a basis of the verified identified key.

2. The apparatus according to claim 1, wherein the apparatus is configured to:
verify the identified key on the basis of the obtained attestation and on a basis of a preceding key in the sequence of keys, the preceding key having a preceding key identifier in the sequence of key identifiers that is disposed directly in front of the identified key identifier in the sequence of key identifiers.

3. The apparatus according to claim 1, wherein the apparatus is configured to:
identify the first key identifier in the sequence of key identifiers using a key memory, wherein the key memory indicates zero, one, or more verified keys, and key identifiers thereof, that have already been verified for the vehicle.

4. The apparatus according to claim 3, wherein the apparatus is configured to:
include the verified identified key with the identified key identifier in the key memory.

5. The apparatus according to claim 1,
wherein the sequence of key identifiers has N key identifiers n=1, . . . , N, with N≥2,
wherein an N-th key identifier is the key identifier for the target key of the device, and
wherein the identified key identifier corresponds to an n1-th key identifier in the sequence of key identifiers, where 1≤n₁<N.

6. The apparatus according to claim 5, wherein the apparatus is configured to:
verify the key with the subsequent (n₁+1)-th key identifier in the sequence of key identifiers by using the attestation for the key with the subsequent (n₁+1)-th key identifier, and by using the previously verified key with the n₁-th key identifier.

7. The apparatus according to claim 5,
wherein, in order to finally verify the target key of the device as the key with the N-th key identifier, the apparatus is configured to, iteratively for n=n₁+1 to N:
obtain the attestation for the key with the n-th key identifier; and
verify the key with the n-th key identifier on a basis of the respective obtained attestation and by using a key with an (n−1)-th key identifier.

8. The apparatus according to claim 1,
wherein the attestation for the identified key:
has been signed using a central key of a central processing unit that has generated the sequence of keys; and/or
has been signed using a preceding key that has a preceding key identifier in the sequence of key identifiers that is disposed directly in front of the identified key identifier in the sequence of key identifiers.

9. The apparatus according to claim 1,
wherein the sequence of key identifiers and/or the attestation are stored on the device and are obtained by the vehicle via a wireless communication connection.

10. The apparatus according to claim 1,
wherein the sequence of key identifiers indicates a version of each of the individual keys used in the corresponding sequence of keys,
wherein one or more keys in the corresponding sequence of keys have a version from multiple different possible versions, and
wherein the apparatus is configured to:
identify the first key identifier in the sequence of key identifiers for a corresponding first key in the sequence of keys that has not yet been verified for the vehicle with the respective indicated version.

11. The apparatus according to claim 1, wherein the apparatus is configured to:
use the identified key identifier to determine a subarea of a memory area of the device in which the attestation for the identified key is stored; and
read the attestation for the identified key from the determined subarea.

12. The apparatus according to claim 1,
wherein each of the individual keys of the sequence of keys is designed according to the Car Connectivity Consortium (CCC) key standard.

13. A method for checking a digital target key of a device for a vehicle, the method comprising:
determining a sequence of key identifiers for a corresponding sequence of digital keys that have been used to derive the target key;
identifying a first key identifier in the sequence of key identifiers for a corresponding first key in the sequence of keys that has not yet been verified for the vehicle;
obtaining an attestation for the identified key from the device;
verifying the identified key on a basis of the obtained attestation; and
checking the target key of the device on a basis of the verified identified key.

14. The method according to claim 13, comprising:
verifying the identified key on the basis of the obtained attestation and on a basis of a preceding key in the sequence of keys, the preceding key having a preceding key identifier in the sequence of key identifiers that is disposed directly in front of the identified key identifier in the sequence of key identifiers.

15. The method according to claim 13, comprising:
identifying the first key identifier in the sequence of key identifiers using a key memory, wherein the key memory indicates zero, one, or more verified keys, and key identifiers thereof, that have already been verified for the vehicle.

16. The method according to claim 15, comprising:
including the verified identified key with the identified key identifier in the key memory.

17. The method according to claim 13,
wherein the attestation for the identified key:
has been signed using a central key of a central processing unit that has generated the sequence of keys; and/or
has been signed using a preceding key that has a preceding key identifier in the sequence of key identifiers that is disposed directly in front of the identified key identifier in the sequence of key identifiers.

18. The method according to claim 13,
wherein the sequence of key identifiers indicates a version of each of the individual keys used in the corresponding sequence of keys,
wherein one or more keys in the corresponding sequence of keys have a version from multiple different possible versions, and
the method comprising:
identifying the first key identifier in the sequence of key identifiers for a corresponding first key in the sequence of keys that has not yet been verified for the vehicle with the respective indicated version.

19. The method according to claim 13, comprising:
using the identified key identifier to determine a subarea of a memory area of the device in which the attestation for the identified key is stored; and
reading the attestation for the identified key from the determined subarea.

20. A method for checking a digital target key of a device for a vehicle, the method comprising:
providing a sequence of key identifiers for a corresponding sequence of keys that have been used to derive the target key;
receiving a request to provide an attestation for a key in the sequence of keys that has been identified by a key identifier in the sequence of key identifiers; and
providing the requested attestation via a wireless communication connection.
